(19) United States
(12) Patent Application Publication
(10) Pub. No.: US 2015/0136688 A1
(43) Pub. Date: May 21, 2015

(54) MEMBRANE, WATER TREATMENT MEMBRANE, WATER TREATMENT DEVICE, AND METHOD OF MANUFACTURING THE MEMBRANE

(71) Applicant: Samsung Electronics Co., Ltd., Suwon-Si (KR)

(72) Inventors: Jun Hyuk MOON, Daejon (KR); Hyoung Woo CHOI, Hwaseong-si (KR); Sung Soo HAN, Hwaseong-si (KR)

(73) Assignee: SAMSUNG ELECTRONICS CO., LTD., Suwon-Si, Gyeonggi-Do (KR)

(21) Appl. No.: 14/283,871

(22) Filed: May 21, 2014

(30) Foreign Application Priority Data
Nov. 18, 2013 (KR) 10-2013-0139974

(51) Int. Cl. C02F 1/44; B01D 61/14; B01D 61/00; B01D 61/02; B01D 71/62; B01D 67/00

(52) U.S. Cl. CPC C02F 1/441; C02F 1/445; C02F 1/444; C02F 1/442; B01D 71/62; B01D 67/0006; B01D 61/002; B01D 61/025; B01D 61/027; B01D 61/145; B01D 61/147; C02F 2103/08
USPC 210/490; 524/718; 210/493.1; 210/500.33

(57) ABSTRACT

A membrane may include a polymer matrix and a compound represented by Chemical Formula 1,

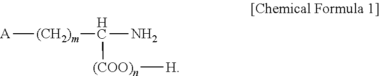

In Chemical Formula 1, A is a substituted or unsubstituted C3 to C10 aromatic cyclic group, m is an integer of 0 to 5, and n is 0 or 1, provided that m and n are not simultaneously 0 (e.g., when A is an unsubstituted benzene group). A separation membrane for water treatment may include the membrane. A water treatment device may include the separation membrane for water treatment.

### CROSS-REFERENCE TO RELATED APPLICATION

This application claims priority under 35 U.S.C. §119 to Korean Patent Application No. 10-2013-0139974, filed in the Korean Intellectual Property Office on Nov. 18, 2013, the entire contents of which are incorporated herein by reference.

### BACKGROUND

1. Field

The present disclosure relates to a membrane having a relatively high water reflux and salt rejection rate due to an additive, a separation membrane for water treatment including the membrane, a water treatment device including the separation membrane for water treatment, and a method of manufacturing the membrane.

2. Description of the Related Art

A semi-permeable membrane is conventionally used among various processes of treating a solution including various materials to exclude the subject materials to be removed (e.g., salts). Particularly, a semi-permeable membrane having a relatively high performance is required to obtain water having a desired quality level (e.g., drinking water, ultra-pure water) by removing salts and organic materials from the water including the salts and organic materials at a relatively high concentration such as sea water in reverse osmosis and forward osmosis processes. In particular, a semi-permeable membrane having a higher water reflux but lower salt passage is required to increase water treatment efficiency.

### SUMMARY

According to some example embodiments, the present disclosure relates to a membrane having improved selectivity and permeability.

According to some example embodiments, the present disclosure relates to a separation membrane for water treatment including the membrane.

According to some example embodiments, the present disclosure relates to a water treatment device including the separation membrane for water treatment.

According to some example embodiments, the present disclosure relates to a method of manufacturing the membrane.

A membrane may include a polymer matrix and a compound represented by the following Chemical Formula 1.

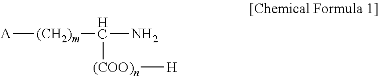

In the above Chemical Formula 1, A is a substituted or unsubstituted C3 to C10 aromatic cyclic group, m is an integer of 0 to 5, and n is 0 or 1, provided that m and n are not simultaneously 0 (e.g., when A is an unsubstituted benzene group).

The aromatic cyclic group may be a substituted or unsubstituted benzene group, a substituted or unsubstituted naphthalene group, a substituted or unsubstituted indole group, a substituted or unsubstituted pyrazine group, a substituted or unsubstituted imidazole group, a substituted or unsubstituted pyrazole group, a substituted or unsubstituted oxazole group, a substituted or unsubstituted pyrimidine group, a substituted or unsubstituted oxadiazole group, a substituted or unsubstituted triazole group, a substituted or unsubstituted pyridine group, a substituted or unsubstituted triazine group, a substituted or unsubstituted isoxazole group, a substituted or unsubstituted tetrazole group, a substituted or unsubstituted benzimidazole, a substituted or unsubstituted indazole, or a combination thereof.

The compound represented by the above Chemical Formula 1 may be derived from an amino acid, an oligo-peptide, or a combination thereof.

The compound represented by the above Chemical Formula 1 may have a molecular weight of about 100 to about 700.

The compound represented by the above Chemical Formula 1 may be tryptophan, tyrosine, phenethylamine, tryptamine, or a combination thereof.

The polymer matrix may include an amide group-containing polymer, and the amide group-containing polymer may be linked by an amide bond with the amine group (—NH₂) of the compound represented by the above Chemical Formula 1.

The polymer matrix may include a polymer selected from a polyamide, a cross-linked polyamide, a polyamide-hydrazide, a poly(amide-imide), and a combination thereof.

The compound represented by the above Chemical Formula 1 may be included in an amount of about 0.1 mol % to about 50 mol % based on the total amount of the polymer matrix.

The surface of the membrane may include a folded structure that is about 0.1 nm to about 10 nm-thick.

A separation membrane for water treatment may include the membrane.

The membrane may have a thickness of about 0.01 μm to about 100 μm.

The separation membrane for water treatment may further include a porous support layer.

The porous support layer may include a polymer selected from a polysulfone-based polymer selected from polysulfone, polyethersulfone, and poly(ethersulfoneketone); a poly(meth)acrylonitrile polymer selected from polyacrylonitrile and polymethacrylonitrile; a polyolefin-based polymer selected from polyethylene, polypropylene, and polystyrene; polycarbonate; a polyalkylene terephthalate selected from polyethylene terephthalate and polybutylene terephthalate; a polyimide-based polymer; a polybenzimidazole-based polymer; a polybenzthiazole-based polymer; a polybenzoxazole-based polymer; a polyepoxy-based polymer; a polyphenylenevinylene-based polymer; a polyamide-based polymer; a cellulose-based polymer; polyvinylidene fluoride (PVDF); polytetrafluoroethylene (PTFE); polyvinyl chloride (PVC); and a combination thereof.

The porous support layer may have a thickness of about 25 μm to about 250 μm.

A water treatment device may include the separation membrane for water treatment.

A method of manufacturing a membrane may include dissolving a first monomer and a compound represented by the following Chemical Formula 1 in a first solvent to prepare a first monomer solution; dissolving a second monomer in a second solvent to prepare a second monomer solution; and contacting the first monomer solution with the second monomer solution on a substrate to carry out an interface polymerization, wherein the first monomer solution includes an aromatic polyamine or aliphatic polyamine monomer, and the second monomer solution includes a multi-functional acyl halide.

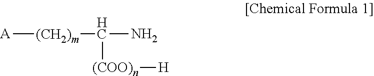

In the above Chemical Formula 1, A is a substituted or unsubstituted C3 to C10 aromatic cyclic group, m is an integer of 0 to 5, and n is 0 or 1, provided that m and n are not simultaneously 0 (e.g., when A is an unsubstituted benzene group).

The compound represented by the above Chemical Formula 1 may be included in an amount of about 1 mol % to about 50 mol % based on the total amount of a solute in the first monomer solution.

The first monomer may be an aromatic polyamine selected from diaminobenzene, triaminobenzene, m-phenylenediamine, p-phenylenediamine, 1,3,5-triaminobenzene, 1,3,4-triaminobenzene, 3,5-diaminobenzoic acid, 2,4-diaminotoluene, 2,4-diaminoanisole, xylylenediamine, and a combination thereof, or an aliphatic polyamine selected from ethylenediamine, propylenediamine, piperazine, tris-(2-diaminoethyl)amine, and a combination thereof.

The second monomer may be a multi-functional acyl halide selected from trimesoyl chloride (TMC), trimellitic chloride, isophthaloyl chloride, terephthaloyl chloride, and a combination thereof.

The first monomer may be included in an amount of about 1 mol % to about 10 mol % based on a total amount of the first solvent.

The second monomer may be included in an amount of about 0.05 mol % to about 0.3 mol % based on a total amount of the second solvent.

### BRIEF DESCRIPTION OF THE DRAWINGS

FIG. 1 is a graph showing reaction rate and reaction amount characteristics of a membrane according to one example embodiment.

FIGS. 2(a) to 2(c) are graphs showing performance change of the membrane depending on the amount of an additive according to an example embodiment.

FIG. 3 is a scanning transmission electron microscope (STEM) photograph showing a material distribution of a separation membrane for water treatment according to an example embodiment.

FIG. 4 is a transmission electron microscope (TEM) photograph showing a folded structure formed on the surface of the membrane according to an example embodiment.

### DETAILED DESCRIPTION

This disclosure will be described more fully hereinafter in the following detailed description, in which some but not all embodiments of this disclosure are described. However, this disclosure may be embodied in many different forms and is not construed as limited to the example embodiments set forth herein.

It will be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It will be understood that, although the terms first, second, third, etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, e.g., “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms, “comprises,” “comprising,” “includes,” and/or “including,” if used herein, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing.

Unless otherwise defined, all terms (including technical and scientific terms) used herein have the same meaning as commonly understood by one of ordinary skill in the art. It will be further understood that terms, including those defined in commonly used dictionaries, should be interpreted as having a meaning that is consistent with their meaning in the context of the relevant art and will not be interpreted in an idealized or overly formal sense unless expressly so defined herein. As used herein, when a definition is not otherwise provided, the term “substituted” refers to one substituted with a halogen atom (F, Cl, Br, or I), a hydroxy group, a nitro group, a cyano group, an imino group (═NH, ═NR′, wherein R′ is a C1 to C10 alkyl group), an amino group (—NH₂, —NH(R″, —N(R′″)(R″″), wherein R″ to R″″ are independently a C1 to C10 alkyl group), an amidino group, a hydrazine group, a hydrazone group, a carboxyl group, or a C1 to C30 alkyl group; a C1 to C30 alkylsilyl group; a C3 to C30 cycloalkyl group; a C2 to C30 heterocycloalkyl group; a C6 to C30 aryl group; a C2 to C30 heteroaryl group; a C1 to C30 alkoxy group; or a C1 to C30 fluoroalkyl group.

As used herein, when a definition is not otherwise provided, the prefix “hetero” may refer to one including 1 to 3 heteroatoms selected from N, O, S, and P, with the remaining structural atoms in a compound or a substituent being carbons.

As used herein, when a definition is not otherwise provided, the term “combination thereof” refers to at least two substituents bound to each other by a linker, or at least two substituents condensed to each other.

As used herein, when a definition is not otherwise provided, the term “alkyl group” may refer to a saturated alkyl group without an alkenyl group or an alkynyl group, or an unsaturated alkyl group including at least one of an alkenyl group or an alkynyl group. The term “alkenyl group” may refer to a substituent in which at least two carbon atoms are bound with at least one carbon-carbon double bond, and the term “alkynyl group” refers to a substituent in which at least two carbon atoms are bound with at least one carbon-carbon triple bond. The alkyl group may be a branched, linear, or cyclic alkyl group.

The alkyl group may be a C1 to C20 alkyl group, and more specifically a C1 to C6 alkyl group, a C7 to C10 alkyl group, or a C11 to C20 alkyl group.

For example, a C104 alkyl may have 1 to 4 carbon atoms, and may be selected from methyl, ethyl, propyl, iso-propyl, n-butyl, iso-butyl, sec-butyl, and t-butyl.

Examples of the alkyl group include a methyl group, an ethyl group, a propyl group, an isopropyl group, a butyl group, an isobutyl group, a t-butyl group, a pentyl group, a hexyl group, an ethenyl group, a propenyl group, a butenyl group, a cyclopropyl group, a cyclobutyl group, a cyclopentyl group, a cyclohexyl group, and the like.

The term “aromatic group” may refer to a substituent including a cyclic structure where all elements have p-orbitals which form conjugation. Examples of an aromatic group may include an aryl group and a heteroaryl group.

“The term “aryl group” may refer to a monocyclic or fused ring-containing polycyclic (i.e., rings sharing adjacent pairs of carbon atoms) groups.

The term “heteroaryl group” may refer to one including 1 to 3 heteroatoms selected from N, O, S, or P in an aryl group, with the remaining structural atoms being carbons. When the heteroaryl group is a fused ring, each ring may include 1 to 3 heteroatoms.

In the drawings, the thickness of layers, films, panels, regions, etc., may have been exaggerated for clarity. It will be understood that when an element such as a layer, film, region, or substrate is referred to as being “on” another element, it can be directly on the other element or intervening elements may also be present. In contrast, when an element is referred to as being “directly on” another element, there are no intervening elements present.

Hereinafter, a membrane according to one embodiment is described.

A membrane according to one example embodiment may include a polymer matrix and a compound represented by the following Chemical Formula 1.

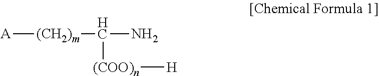

In the above Chemical Formula 1,

A is a substituted or unsubstituted C3 to C10 aromatic cyclic group,

m is an integer of 0 to 5, and

n is 0 or 1,

provided that m and n are not simultaneously 0 (e.g., when A is an unsubstituted benzene group).

For example, the aromatic cyclic group may be a substituted or unsubstituted benzene group, a substituted or unsubstituted naphthalene group, a substituted or unsubstituted indole group, a substituted or unsubstituted pyrazine group, a substituted or unsubstituted imidazole group, a substituted or unsubstituted pyrazole group, a substituted or unsubstituted oxazole group, a substituted or unsubstituted pyrimidine group, a substituted or unsubstituted oxadiazole group, a substituted or unsubstituted triazole group, a substituted or unsubstituted pyridine group, a substituted or unsubstituted triazine group, a substituted or unsubstituted isoxazole group, a substituted or unsubstituted tetrazole group, a substituted or unsubstituted benzimidazole, a substituted or unsubstituted indazole, or a combination thereof, but is not limited thereto.

For example, the compound represented by the above Chemical Formula 1 may have a molecular weight of about 100 to about 700.

The membrane includes a polymer matrix as aforementioned, and the polymer matrix may be formed of an amide group-containing polymer. The amide group-containing polymer may be connected with an amine group (—NH₂) in the compound represented by the above Chemical Formula 1 through an amide bond. The amide group-containing polymer may structurally include an amide group, but the amide group inside the structure has no particular limit in its distribution shape, amount, or the like.

For example, the polymer matrix may include a polymer selected from a polyamide, a cross-linked polyamide, a polyamide-hydrazide, a poly(amide-imide), and a combination thereof, but is not limited thereto.

The membrane may include a multi-functional amine derivative or a multi-functional acyl halide derivative other than the compound represented by the above Chemical Formula 1.

The multi-functional amine may be, for example an aromatic polyamine selected from diaminobenzene, triaminobenzene, m-phenylenediamine, p-phenylenediamine, 1,3,5-triaminobenzene, 1,3,4-triaminobenzene, 3,5-diaminobenzoic acid, 2,4-diaminotoluene, 2,4-diaminoanisole, xylylenediamine, and a combination thereof, or an aliphatic polyamine selected from ethylenediamine, propylenediamine, piperazine, tris-(2-diaminoethyl)amine), and a combination thereof, but is not limited thereto.

The multi-functional acyl halide may be selected from, for example, trimesoyl chloride (TMC), trimellitic chloride, isophthaloyl chloride, terephthaloyl chloride, and a combination thereof, but is not limited thereto.

The compound represented by the above Chemical Formula 1 simultaneously includes an amine group (—NH₂) and an aromatic cyclic group structurally in a molecule. In addition, the compound represented by the above Chemical Formula 1 may include a carboxyl group (—COON) in one molecule.

The compound has a structure of the above Chemical Formula 1 and thus may be effectively permeated into the polymer matrix and further improve a cross-linking degree inside the membrane.

The compound represented by the above Chemical Formula 1 may have a solubility parameter in a range of about 15 to about 26 J^{1/2}cm^{-3/2}. When the solubility parameter is within the range, materials included in the membrane may be appropriately dispersed inside the polymer matrix. In this regard, the compound represented by the above Chemical Formula 1 may have a solubility parameter ranging from about 15 to about 26 J^{1/2}cm^{-3/2}.

In the membrane, the multi-functional amine and the multi-functional acyl may react with each other and produce hydrogen chloride (HCl) as a byproduct (R₁—NH₂+R₂—COCl→R₁—NHCO—R₂+HCl). The produced hydrogen chloride has a hydrolysis reaction with the compound represented by the above Chemical Formula 1, and thus may be removed without a separate acid scavenger (R₁—NHCO—R₂+H₂O+HCl→R₁—NH₂+R₂—COOH+HCl).

In this way, the compound represented by the above Chemical Formula 1 may play a role of gradually lowering pH as a buffer inside the membrane.

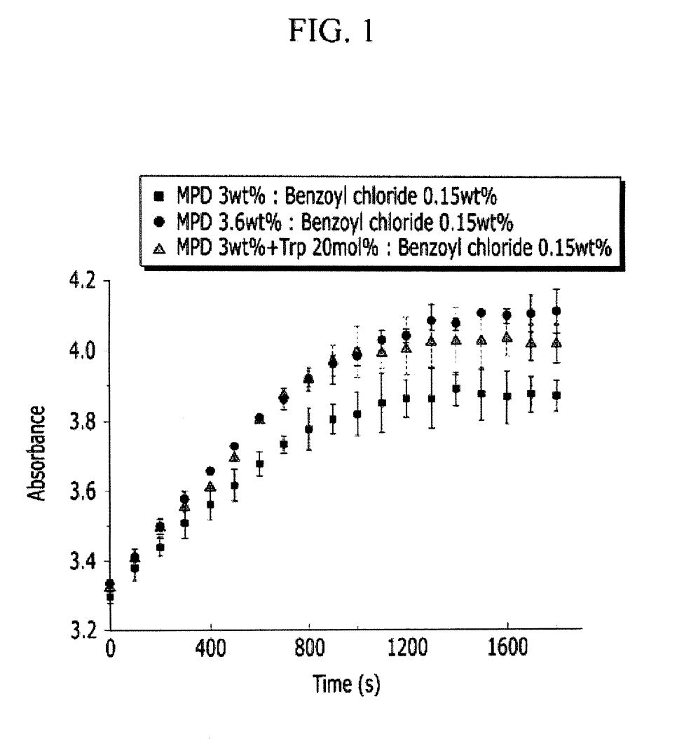

The membrane according to one example embodiment includes the compound represented by the above Chemical Formula 1, and thus may increase a reaction amount and a reaction rate without increasing thickness of the membrane. The membrane will be described referring to FIG. 1.

FIG. 1 is a graph showing reaction rate and reaction amount characteristics of the membrane according to one example embodiment.

In order to examine reaction characteristics of the membrane including the compound represented by the above Chemical Formula 1, light absorption degrees of a membrane including m-phenylenediamine (MPD), tryptophan (Trp) and benzoyl chloride (3 wt % of MPD: 20 mol % of Trp ([Trp]/[MPD]): 0.15 wt % of benzoyl chloride), and another membrane including m-phenylenediamine (MPD) and benzoyl chloride (3 wt % of MPD: 0.15 wt % of benzoyl chloride and 3.6 wt % of MPD: 0.15 wt % of benzoyl chloride) at a wavelength of 290 nm are respectively evaluated. The amounts of the MPD and the benzoyl chloride are respectively measured based on 100 wt % of water and hexane as a solvent.

Referring to FIG. 1, the membrane including the tryptophan shows an increased reaction amount and reaction rate compared with the membrane including the MPD and the benzoyl chloride (3 wt % of MPD: 0.15 wt % of benzoyl chloride) in the same amount. In addition, the membrane including the tryptophan shows a similar reaction amount and reaction rate to the membrane including the MPD in a higher amount and the benzoyl chloride (3.6 wt % of MPD: 0.15 wt % of benzoyl chloride). In other words, when the tryptophan as an additive is used for a membrane, the reaction amount and reaction rate of the membrane increase without increasing concentration of the MPD, and accordingly, a polymerization degree of the membrane may be increased without increasing thickness of the membrane.

The compound represented by the above Chemical Formula 1 is water-soluble and thus may be dissolved in water and then added to the membrane as an aqueous solution.

The compound represented by the above Chemical Formula 1 may be included in an amount of about 0.1 mol % to about 50 mol % based on the total amount of the polymer matrix, but is not limited thereto. The compound represented by the above Chemical Formula 1 may be included in an amount of, for example, about 1 mol % to about 100 mol % based on the multi-functional amine, but is not limited thereto. When the compound is included within the range, the membrane may have a higher reaction degree, while the amount of non-reaction may be reduced or minimized.

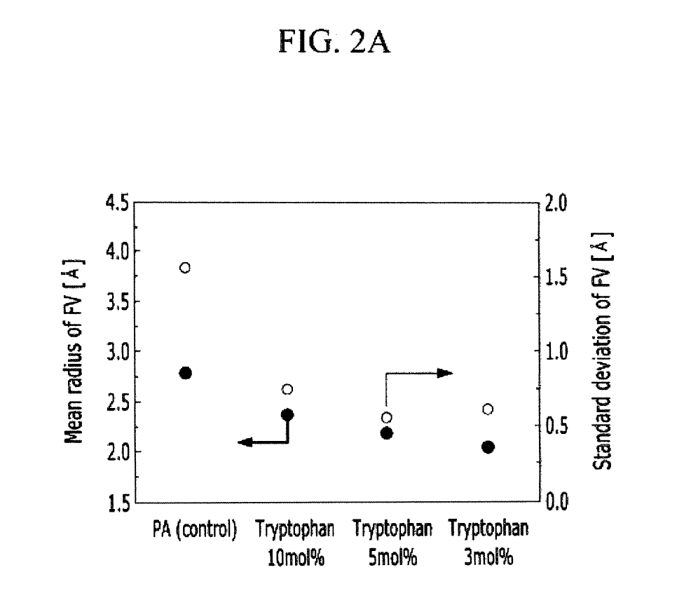

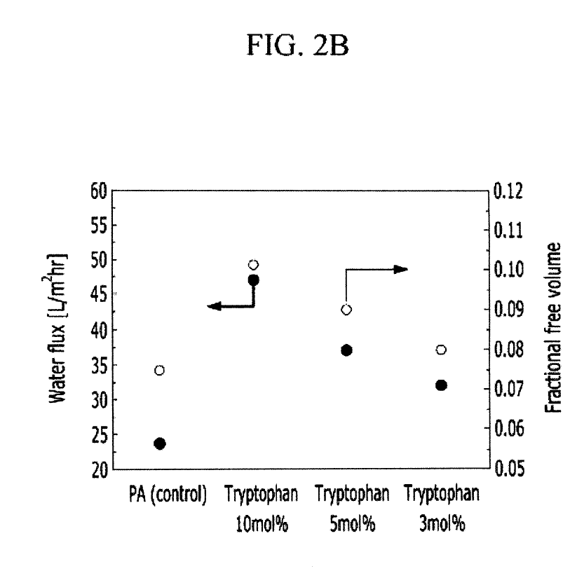

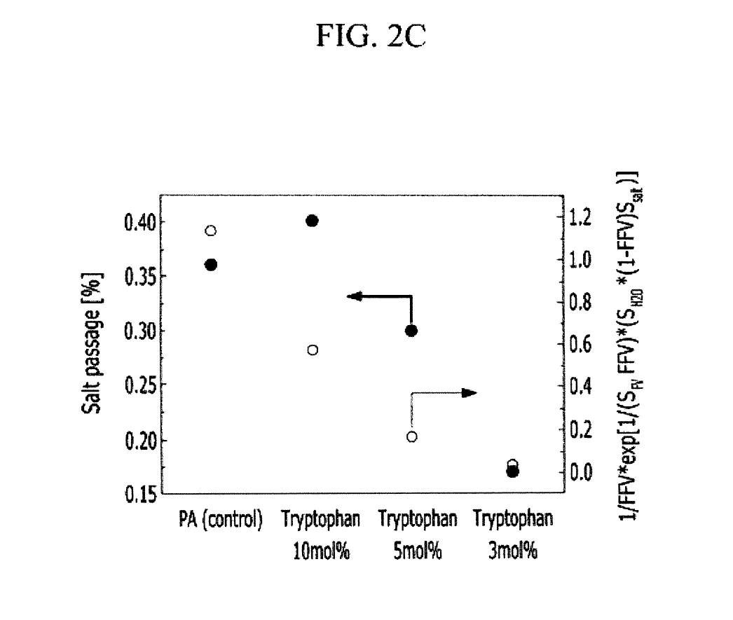

FIGS. 2A to 2C are graphs showing performance change of a membrane depending on the amount of additives.

As for a membrane including m-phenylenediamine (MPD) and tryptophan (Trp) (respectively, 3 mol %, 5 mol %, and 10 mol % relative to the MPD) and another membrane including m-phenylenediamine (MPD) but no tryptophan (Trp), fractional free volume (FFV), water flux, and salt passage characteristics of the membranes are evaluated.

In FIG. 2A, the black and white dots are all obtained through a simulation, and indicate mean and standard deviation of free volume (FV) of the membranes depending on the addition of the tryptophan. In FIGS. 2B and 2C, the black dots are obtained through an actual experiment while the white dots are obtained through a simulation, and FIG. 2B shows water flux depending on the addition of tryptophan and FIG. 2C shows a salt passage rate of the membranes and its standard deviation depending on the addition of the tryptophan. The water flux and salt passage rate are calculated according to the following Equation 1.

$$Water flux \\ Jw = \frac{{P}_{w}}{L} ( Δ P - Δπ ) ∼ exp ( - \frac{1}{{f}_{w}} ) \\ Salt passage \\ {T}_{salt} = \frac{{P}_{s}}{{P}_{w}} \frac{1}{( Δ P - Δπ )} ∼ \frac{1}{{f}_{w}} exp ( \frac{1}{{V}_{f} {f}_{w}} [ {S}_{w} - ( 1 - {f}_{w} ) {S}_{s} ] ) \\ {V}_{f} \text{:} Free Volume ( FV ) \\ {f}_{w} \text{:} the volume fraction of water \\ {S}_{s} \text{:} the cross \text{-} sectional area of salt \qquad [ Equation 1 ]$$

Referring to FIGS. 2A to 2C, membrane performance may be adjusted depending on the amount of additive. The reason is that physical characteristics of the membrane, that is, a free volume characteristic inside the membrane, is changed depending on the amount change of the additive. The values obtained through the simulation tend to correspond with the values obtained through the actual experiment.

According to another example embodiment, a separation membrane for water treatment including the membrane is provided. The separation membrane for water treatment includes the membrane including a polymer matrix and the compound represented by the above Chemical Formula 1, and may secure desired water reflux and salt passage.

The membrane may have a thickness of, for example, about 0.01 to about 100 μm, and specifically, about 0.03 to about 10 μm. When the thickness is within the range, the water reflux and salt rejection rate of a separation membrane for water treatment may be simultaneously obtained at a desirable level.

The separation membrane for water treatment may be a composite membrane further including a porous support layer other than the membrane.

The membrane is positioned on the porous support layer and may play a role of an active layer of the separation membrane for water treatment. The membrane may exhibit semi-permeability so as to pass water but block salt.

The porous support layer may be, for example, a polysulfone-based polymer of polysulfone, polyethersulfone, poly(ethersulfoneketone), and the like; a poly(meth)acrylonitrile polymer of polyacrylonitrile, polymethacrylonitrile, and the like; a polyolefin-based polymer of polyethylene, polypropylene, polystyrene, and the like; polycarbonate; a polyalkylene terephthalate of polyethylene terephthalate, polybutylene terephthalate, and the like; a polyimide-based polymer; a polybenzimidazole-based polymer; a polybenzthiazole-based polymer; a polybenzoxazole-based polymer; a polyepoxy-based polymer; a polyphenylenevinylene-based polymer; a polyamide-based polymer; a cellulose-based polymer; polyvinylidene fluoride (PVDF); polytetrafluoroethylene (PTFE); polyvinyl chloride (PVC); and a combination thereof, but is not limited thereto.

The porous support layer may have, for example, a thickness of about 25 μm to about 250 μm. When the thickness is within the range, a separation membrane for water treatment may maintain a desired level of water reflux while simultaneously possessing an appropriate level of strength.

The separation membrane for water treatment may include the membrane positioned on a porous support layer, and herein, the membrane works as an active layer functionally performing separation in the separation membrane for water treatment, and the porous support layer may work as a support layer supporting the membrane.

The separation membrane for water treatment may include a polysulfone (PS) as a component for the porous support layer and a polyamide (PA) as a component for the membrane.

For example, the polyamide (PA) membrane may be separated from a composite membrane by repeatedly treating an organic material such as chloroform. Existence of the compound derivative represented by Chemical Formula 1 and its reaction with a polymer matrix in the membrane are examined by using solid-state NMR according to a cross-polarization technique in a MAS (magic angle spinning) state.

The separation membrane for water treatment may include very tiny pores at the contact part between the porous support layer and the membrane.

The separation membrane for water treatment may include a region where a porous support layer component (e.g., polysulfone) and a polymer component (e.g., polyamide) of the membrane are mixed, and another region where only the polymer component is present.

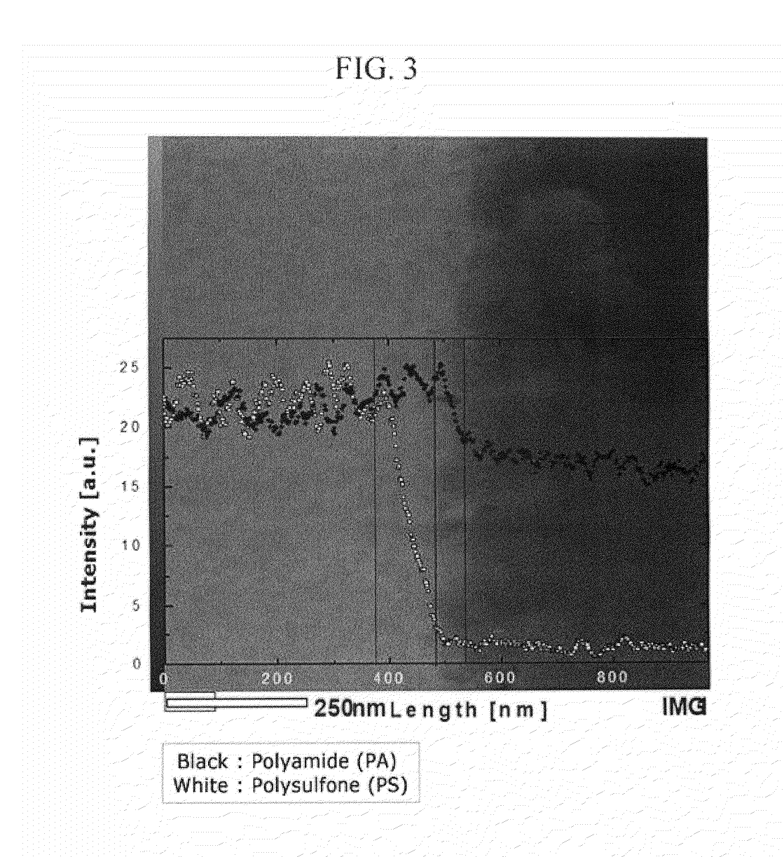

FIG. 3 is a scanning transmission electron microscope (STEM) photograph showing a separation membrane for water treatment according to one example embodiment and an energy dispersion spectroscopy (EDS) photograph showing material distribution of the separation membrane for water treatment. Referring to FIG. 3, the cross-section of the separation membrane includes a region where polyamide (PA) and polysulfone (PS) are distributed together and another region where only polyamide (PA) is present, and the regions respectively have thicknesses of about 122.7 nm and about 39.7 nm.

The pore, for example, a nano-sized pore, may not be present in the region where only the polyamide is present in the separation membrane for water treatment.

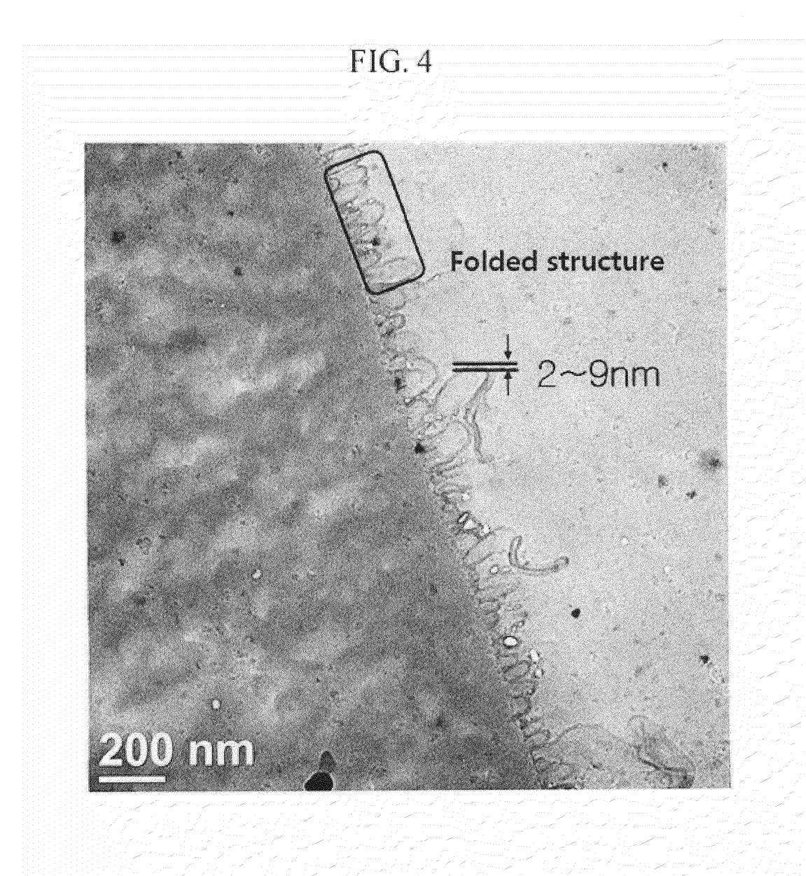

The separation membrane for water treatment may include a folded structure on the surface of the membrane, and the folded structure may have a thickness of about 0.1 nm to about 10 nm. Further illustration about this is provided referring to FIG. 4.

FIG. 4 is a transmission electron microscope (TEM) photograph showing the folded structure on the surface of the membrane in the separation membrane for water treatment. Referring to FIG. 4, the folded structure may be about 2 nm to about 9 nm thick on the surface of the membrane.

According to another example embodiment, a method of manufacturing a membrane may include preparing a first monomer solution; preparing a second monomer solution; and contacting the first monomer solution with the second monomer solution on a substrate to carry out an interface polymerization, wherein the first monomer solution includes an aromatic polyamine or aliphatic polyamine monomer, and the second monomer solution includes a multi-functional acyl halide.

The first monomer solution may be prepared by dissolving a first monomer and the compound represented by the above Chemical Formula 1 in the first solvent, and the second monomer solution may be prepared by dissolving a second monomer in a second solvent.

For example, the first monomer may be an aromatic polyamine selected from diaminobenzene, triaminobenzene, m-phenylene diamine, p-phenylene diamine, 1,3,5-triaminobenzene, 1,3,4-triaminobenzene, 3,5-diaminobenzoic acid, 2,4-diaminotoluene, 2,4-diaminoanisole, xylylene diamine, and a combination thereof, or an aliphatic polyamine selected from ethylene diamine, propylenediamine, piperazine, tris-(2-diaminoethyl)amine, and a combination thereof, but is not limited thereto.

For example, the second monomer may be a multi-functional acyl halide trimesoyl chloride (TMC), trimellitic chloride, isophthaloyl chloride, terephthaloyl chloride, and a combination thereof, but is not limited thereto.

The first solvent and second solvent may be immiscible with each other.

The first solvent may be a polar solvent selected from water, acetonitrile, dimethylformamide, and a mixture thereof, and the second solvent may be a nonpolar solvent selected from a C5 to C30 aliphatic hydrocarbon (e.g., hexane, decane, and the like), a C5 to C10 aromatic hydrocarbon (e.g., xylene, toluene, and the like), dimethylsulfoxide, dimethylacrylamide, methylpyrrolidone, and a mixture thereof.

For example, the first monomer may be included in an amount of about 1 mol % to about 10 mol % based on a total amount of the first solvent, and the second monomer may be included in an amount of about 0.05 mol % to about 0.3 mol % based on a total amount of the second solvent.

For example, the compound represented by the above Chemical Formula 1 may be included in an amount of about 1 mol % to about 50 mol % based on the total amount of a solute in the first monomer solution.

The compound represented by the above Chemical Formula 1 is illustrated in detail as aforementioned, and thus will not be repeated.

The separation membrane for water treatment may be a microfiltration membrane, an ultrafiltration membrane, a nanofiltration membrane, a reverse osmotic membrane, or a forward osmosis membrane, according to its uses.

Such a water treatment separation membrane may be used in various water treatment devices, for example, a reverse osmosis water treatment device, a forward osmosis water treatment device, and the like, without limitation.

The water treatment device may be used for, for example, purification treatment, waste water treatment and reuse, and desalination of sea water.

Hereinafter, some embodiments are illustrated in more detail with reference to various examples. However, the following are merely example embodiments of the present disclosure, and the present disclosure is not limited thereto.

### Separation Membrane for Water Treatment Including Membrane

### Example 1

A first monomer solution is prepared by dissolving m-phenylenediamine (MPD; Sigma-Aldrich) in a concentration of 3.4 wt % and L-tryptophan (Sigma-Aldrich) in a concentration of 1 mol % based on the total solution-phase solute. A second solution is prepared by dissolving trimesoyl chloride (TMC; Sigma-Aldrich) in a concentration of 0.15 wt % in an Isopar-E (SK Chemical) solvent (a second solvent).

Then, a polysulfone porous support (PS35; Sepro Membranes) is dipped in the first monomer solution for 10 minutes and then rolled, and water drops on the surface of the polysulfone porous support are removed to prepare the polysulfone porous support coated on the first monomer solution. Subsequently, the polysulfone porous support coated on the first monomer solution is dipped and reacted in the second monomer solution for 1 minute, forming a membrane.

The membrane is then washed with n-hexane (Sigma-Aldrich) to manufacture a separation membrane for water treatment.

### Example 2

A separation membrane for water treatment is manufactured according to a substantially equivalent method to that of Example 1, except for using 3 mol % of L-tryptophan based on the entire solute in the first monomer solution.

### Example 3

A separation membrane for water treatment is manufactured according to a substantially equivalent method to that of Example 1, except for using 5 mol % of L-tryptophan based on the entire solute in the first monomer solution.

### Example 4

A separation membrane for water treatment is manufactured according to a substantially equivalent method to that of Example 1, except for using 10 mol % of L-tryptophan based on the entire solute in the first monomer solution.

### Example 5

A separation membrane for water treatment is manufactured according to a substantially equivalent method to that of Example 1, except for using 0.14 wt % of trimesoyl chloride based on the second solvent.

### Example 6

A separation membrane for water treatment is manufactured according to a substantially equivalent method to that of Example 1, except for using 0.17 wt % of trimesoyl chloride based on the second solvent.

### Example 7

A separation membrane for water treatment is manufactured according to the same method as Example 1, except for using L-tyrosine (Sigma-Aldrich) in a concentration of 1 mol % based on the total solution-phase solute in the first monomer solution instead of the L-tryptophan.

### Example 8

A separation membrane for water treatment is manufactured according to the same method as Example 1, except for using L-tyrosine (Sigma-Aldrich) in a concentration of 5 mol % based on the total solution-phase solute in the first monomer solution.

### Example 9

A separation membrane for water treatment is manufactured according to the same method as Example 1, except for using tryptamine (Sigma-Aldrich) in a concentration of 5 mol % based on the total solution-phase solute in the first monomer solution.

### Example 10

A separation membrane for water treatment is manufactured according to the same method as Example 1, except for using phenethylamine (Tokyo Chemical Industry) in a concentration of 5 mol % based on the total solution-phase solute in the first monomer solution.

### Example 11

A separation membrane for water treatment is manufactured according to the same method as Example 1, except for using phenethylamine (Tokyo Chemical Industry) in a concentration of 10 mol % based on the total solution-phase solute in the first monomer solution.

### Comparative Example 1

A second monomer solution is prepared by dissolving m-phenylenediamine in a concentration of 3.4 wt % in water to prepare a first monomer solution, and a second monomer solution is prepared by dissolving trimesoyl chloride in a concentration of 0.15 wt % in an Isopar-E solvent.

Then, a polysulfone porous support is dipped in the first monomer solution for 10 minutes and rolled, and water drops on the surface of the polysulfone porous support are removed, manufacturing the polysulfone porous support coated on the surface of the first monomer solution. Subsequently, the polysulfone porous support coated with the first monomer solution is dipped and reacted in the second monomer solution for one minute to form a membrane.

The membrane is then washed with n-hexane, forming a separation membrane for water treatment.

### Comparative Example 2

A separation membrane for water treatment is manufactured according to the same method as Example 1, except for using indole (Sigma-Aldrich) in a concentration of 5 mol % based on the total solution-phase solute in the first monomer solution.

### Comparative Example 3

A separation membrane for water treatment is manufactured according to the same method as Example 1, except for using L-alanine (Sigma-Aldrich) in a concentration of 3 mol % based on the total solution-phase solute in the first monomer solution.

### Comparative Example 4

A separation membrane for water treatment is manufactured according to the same method as Example 1, except for using L-leucine (Sigma-Aldrich) in a concentration of 3 mol % based on the total solution-phase solute in the first monomer solution.

### Comparative Example 5

A separation membrane for water treatment is manufactured according to the same method as Example 1, except for using L-glutamic acid (Sigma-Aldrich) in a concentration of 3 mol % based on the total solution-phase solute in the first monomer solution.

### Comparative Example 6

A separation membrane for water treatment is manufactured according to the same method as Example 1, except for using L-histidine (Sigma-Aldrich) in a concentration of 3 mol % based on the total solution-phase solute in the first monomer solution.

### Comparative Example 7

A separation membrane for water treatment is manufactured according to the same method as Example 1, except for using benzylamine (Sigma-Aldrich) in a concentration of 5 mol % based on the total solution-phase solute in the first monomer solution.

### Evaluation 1: Water Reflux

The elution speeds of the separation membranes for water treatment according to Examples 1 to 11 and Comparative Examples 1 to 7 are measured. First, each separation membrane is equipped in a cell, and then supplied with a NaCl solution at 32,000 ppm at room temperature (about 25° C.). Herein, the crossflow speed of the NaCl solution is 3 L/min. The separation membrane is consolidated at 55 bar for 2 hours, and its water reflux is evaluated.

The results are provided in the following Table 1.

### Evaluation 2: Salt Rejection Rate

A salt rejection rate of each separation membrane for water treatment according to Examples 1 to 11 and Comparative Examples 1 to 7 is evaluated. First, the separation membrane is equipped in a cell and supplied with NaCl solution at 32,000 ppm at room temperature (about 25° C.). The crossflow rate of the NaCl solution is 3 L/min. The separation membrane is consolidated at 55 bar for 2 hours, and the salt rejection rate of the separation membrane is measured according to the following Equation 2.

R=1−(cp/cb) [Equation 2]

In Equation 2, R indicates a salt rejection rate, cb indicates salt concentration of a bulk feed water, and cp indicates salt concentration of permeated water.

The results are provided in the following Table 1.

TABLE 1

| | | | Water reflux | Salt |
|---|---|---|---|---|
| | | Amount | [L/m² · h] = | passage |
| | Additive | (mol %) | [LMH] | [%] |
| Example 1 | L-Tryptophan | 1 | 23 | 0.23 |
| Example 2 | | 3 | 32 | 0.17 |
| Example 3 | | 5 | 37 | 0.3 |
| Example 4 | | 10 | 47 | 0.4 |
| Example 5 | | 1 | 22 | 0.29 |
| Example 6 | | 1 | 20 | 0.17 |
| Example 7 | L-Tyrosine | 1 | 40 | 0.33 |
| Example 8 | | 5 | 49 | 0.61 |
| Example 9 | Tryptamine | 5 | 38 | 0.2 |
| Example 10 | Phenethylamine | 5 | 27 | 0.15 |
| Example 11 | | 10 | 30 | 0.25 |
| Comparative | — | — | 23.8 | 0.36 |
| Example 1 | | | | |
| Comparative | Indole | 5 | 22 | 0.36 |
| Example 2 | | | | |
| Comparative | L-Alanine | 3 | 26 | 0.48 |
| Example 3 | | | | |
| Comparative | L-Leucine | 3 | 22 | 0.24 |
| Example 4 | | | | |
| Comparative | L-Glutamic acid | 3 | 25 | 0.35 |
| Example 5 | | | | |
| Comparative | L-Histidine | 3 | 25 | 0.43 |
| Example 6 | | | | |
| Comparative | Benzylamine | 5 | 29 | 0.39 |
| Example 7 | | | | |

In Table 2, LMH (L/m²·h) refers to the water passing amount per unit time. In other words, the LMH indicates the amount of water (L) passing 1 m² of a membrane area per unit time of one hour, wherein the L indicates the amount of water (L) passing the membrane, the M indicates the area (m²) of the membrane, and the H indicates the time (hour) for which the water passes.

In the water reflux and salt rejection rate evaluations, water reflux of 24 L/m²h and a salt rejection rate of 0.36% are regarded as a reference point.

Referring to Table 1, the separation membranes for water treatment according to Examples 1 to 11 show better water reflux and salt rejection rates than the reference point compared with the separation membranes for water treatment according to Comparative Examples 1 to 7.

While this disclosure has been described in connection with various example embodiments, it should be understood that the examples are not limited to the disclosed embodiments, but, on the contrary, are intended to cover various modifications and equivalent arrangements included within the spirit and scope of the appended claims.

What is claimed is:

1. A membrane, comprising:
a polymer matrix; and
a compound within the polymer matrix, the compound represented by Chemical Formula 1: 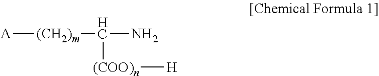
wherein, in Chemical Formula 1,
A is a substituted or unsubstituted C3 to C10 aromatic cyclic group,
m is an integer of 0 to 5, and
n is 0 or 1,
provided that m and n are not simultaneously 0 when A is an unsubstituted benzene group.

2. The membrane of claim 1, wherein the aromatic cyclic group is a substituted or unsubstituted benzene group, a substituted or unsubstituted naphthalene group, a substituted or unsubstituted indole group, a substituted or unsubstituted pyrazine group, a substituted or unsubstituted imidazole group, a substituted or unsubstituted pyrazole group, a substituted or unsubstituted oxazole group, a substituted or unsubstituted pyrimidine group, a substituted or unsubstituted oxadiazole group, a substituted or unsubstituted triazole group, a substituted or unsubstituted pyridine group, a substituted or unsubstituted triazine group, a substituted or unsubstituted isoxazole group, a substituted or unsubstituted tetrazole group, a substituted or unsubstituted benzimidazole, a substituted or unsubstituted indazole, or a combination thereof.

3. The membrane of claim 1, wherein the compound represented by Chemical Formula 1 is derived from an amino acid, an oligo-peptide, or a combination thereof.

4. The membrane of claim 1, wherein the compound represented by Chemical Formula 1 has a molecular weight of about 100 to about 700.

5. The membrane of claim 1, wherein the compound represented by Chemical Formula 1 is tryptophan, tyrosine, phenethylamine, tryptamine, or a combination thereof.

6. The membrane of claim 1, wherein the polymer matrix comprises an amide group-containing polymer, and
the amide group-containing polymer is linked by an amide bond with the amine group (—NH₂) of the compound represented by Chemical Formula 1.

7. The membrane of claim 1, wherein the polymer matrix comprises a polymer selected from a polyamide, a cross-linked polyamide, a polyamide-hydrazide, a poly(amide-imide), and a combination thereof.

8. The membrane of claim 1, wherein the compound represented by Chemical Formula 1 is present in an amount of about 0.1 mol % to about 50 mol % based on a total amount of the polymer matrix.

9. The membrane of claim 1, wherein a surface of the membrane comprises a folded structure, the folded structure being about 0.1 nm to about 10 nm-thick.

10. A separation membrane for water treatment comprising the membrane of claim 1.

11. The separation membrane for water treatment of claim 10, wherein the membrane has a thickness of about 0.01 μm to about 100 μm.

12. The separation membrane for water treatment of claim 10, further comprising:
a porous support layer.

13. The separation membrane for water treatment of claim 12, wherein the porous support layer comprises a polymer selected from a polysulfone-based polymer selected from polysulfone, polyethersulfone, and poly(ethersulfoneketone); a poly(meth)acrylonitrile polymer selected from polyacrylonitrile and polymethacrylonitrile; a polyolefin-based polymer selected from polyethylene, polypropylene, and polystyrene; polycarbonate; a polyalkylene terephthalate selected from polyethylene terephthalate and polybutylene terephthalate; a polyimide-based polymer; a polybenzimidazole-based polymer; a polybenzthiazole-based polymer; a polybenzoxazole-based polymer; a polyepoxy-based polymer; a polyphenylenevinylene-based polymer; a polyamide-based polymer; a cellulose-based polymer; polyvinylidene fluoride (PVDF); polytetrafluoroethylene (PTFE); polyvinyl chloride (PVC); and a combination thereof.

14. The separation membrane for water treatment of claim 12, wherein the porous support layer has a thickness of about 25 μm to about 250 μm.

15. A water treatment device comprising the separation membrane for water treatment of claim 10.

16. A method of manufacturing a membrane, comprising:
dissolving a first monomer and a compound represented by Chemical Formula 1 in a first solvent to prepare a first monomer solution, the first monomer solution including an aromatic polyamine or aliphatic polyamine monomer;
dissolving a second monomer in a second solvent to prepare a second monomer solution, the second monomer solution including a multi-functional acyl halide; and
contacting the first monomer solution with the second monomer solution on a substrate to carry out an interface polymerization, 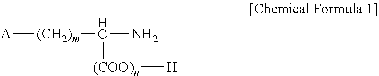
wherein, in Chemical Formula 1,
A is a substituted or unsubstituted C3 to C10 aromatic cyclic group,
m is an integer of 0 to 5, and
n is 0 or 1,
provided that m and n are not simultaneously 0 when A is an unsubstituted benzene group.

17. The method of claim 16, wherein the dissolving a first monomer and a compound represented by Chemical Formula 1 includes dissolving the compound represented by Chemical Formula 1 wherein the aromatic cyclic group is a substituted or unsubstituted benzene group, a substituted or unsubstituted naphthalene group, a substituted or unsubstituted indole group, a substituted or unsubstituted pyrazine group, a substituted or unsubstituted imidazole group, a substituted or unsubstituted pyrazole group, a substituted or unsubstituted oxazole group, a substituted or unsubstituted pyrimidine group, a substituted or unsubstituted oxadiazole group, a substituted or unsubstituted triazole group, a substituted or unsubstituted pyridine group, a substituted or unsubstituted triazine group, a substituted or unsubstituted isoxazole group, a substituted or unsubstituted tetrazole group, a substituted or unsubstituted benzimidazole, a substituted or unsubstituted indazole, or a combination thereof.

18. The method of claim 16, further comprising:
deriving the compound represented by Chemical Formula 1 from an amino acid, an oligo-peptide, or a combination thereof prior to dissolving the first monomer and the compound represented by Chemical Formula 1.

19. The method of claim 16, wherein the compound represented by Chemical Formula 1 has a molecular weight of about 100 to about 700.

20. The method of claim 16, wherein the compound represented by Chemical Formula 1 is tryptophan, tyrosine, phenethylamine, tryptamine, or a combination thereof.

21. The method of claim 16, wherein the dissolving a first monomer and a compound represented by Chemical Formula 1 includes adding the compound represented by Chemical Formula 1 in an amount of 1 mol % to 50 mol % based on a total amount of a solute in the first monomer solution.

22. The method of claim 16, wherein the dissolving a first monomer includes dissolving an aromatic polyamine selected from diaminobenzene, triaminobenzene, m-phenylenediamine, p-phenylenediamine, 1,3,5-triaminobenzene, 1,3,4-triaminobenzene, 3,5-diaminobenzoic acid, 2,4-diaminotoluene, 2,4-diaminoanisole, xylylene diamine, and a combination thereof, or an aliphatic polyamine selected from ethylenediamine, propylenediamine, piperazine, tris-(2-diaminoethyl)amine, and a combination thereof.

23. The method of claim 16, wherein the dissolving a second monomer includes dissolving trimesoyl chloride (TMC), trimellitic chloride, isophthaloyl chloride, terephthaloyl chloride, and a combination thereof.

24. The method of claim 16, wherein the dissolving a first monomer includes adding the first monomer in an amount of about 1 mol % to about 10 mol % based on a total amount of the first solvent.

25. The method of claim 16, wherein the dissolving a second monomer includes adding the second monomer in an amount of about 0.05 mol % to about 0.3 mol % based on a total amount of the second solvent.
